(19) United States
(12) Patent Application Publication
(10) Pub. No.: US 2005/0247200 A1
(43) Pub. Date: Nov. 10, 2005

(54) Moisture exchange module containing a bundle of moisture-permeable hollow fiber membranes

(75) Inventors: Gerhard Berger, Ebersbach (DE); Gert Hinsenkamp, Kirchheim (DE); Jens Intorp, Ulm (DE); Patrick Mangold, Ulm (DE); Jochen Schaefer, Ulm (DE); Sven Schnetzler, Marburg (DE); Wolfgang Weger, Hochdorf (DE); Norbert Wiesheu, Guenzburg (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 11/121,792

(22) Filed: May 4, 2005

(30) Foreign Application Priority Data
May 5, 2004 (DE) DE10 2004022539.7

(51) Int. Cl. B01D 53/22

(52) U.S. Cl. 96/8

(57) ABSTRACT

In an exemplary embodiment of the present invention, a moisture exchange module comprises a moisture-permeable hollow fiber membrane shell space with a bundle of moisture-permeable hollow fiber membranes being arranged in the shell space for receiving a first gas stream. A conduit member is coupled to the shell space for supplying a second gas stream for flow around the hollow fibers. Pursuant to a feature of the exemplary embodiment of the present invention, a mechanism is arranged and configured in the conduit member to produce a swirling motion in the second gas stream.

This application claims priority to German Patent Application 10 2004 022 539.7, filed May 5, 2004, which is hereby incorporated by reference herein.

### BACKGROUND OF THE INVENTION

The present invention is directed to a moisture exchange module containing a bundle of moisture-permeable hollow fiber membranes. The present invention is also directed to the use of such a moisture exchange module.

Reference is made to patent applications JP 2001-202976 A and JP 2003-065566 A as descriptions of known moisture exchange modules. Both documents describe moisture exchange modules containing a bundle of moisture-permeable hollow fiber membranes through which flows a first gas stream. The bundle of hollow fiber membranes is arranged, in each case, in a shell space having a conduit member for supplying a second gas stream flowing around the hollow fibers. In each instance, the conduit member opens into an annular space which surrounds the shell space in an area of its cross-section and from which the second gas stream enters the area of the shell space, and thus, between the hollow fiber membranes.

In document JP 2003-065566, it is a disadvantage that relatively large annular spaces are required as inflow regions to achieve an adequate distribution of the second gas stream into the regions between the actual hollow fiber membranes. Nevertheless, the distribution is still so uneven here that the flow impinges on the hollow fiber membrane areas directly facing the supply conduit much more effectively than on the areas facing away from the supply conduit. As a result of this, some areas within the bundle of hollow fiber membranes are not utilized, or utilized only to an insufficient degree. Therefore, to be able to nevertheless ensure a predetermined moisture exchange capacity, a greater number of hollow fiber membranes must be used, resulting in an increase in size of the moisture exchange module.

In accordance with document JP 2001-202976 A, an improved distribution is indeed achieved by suitable openings in a shell accommodating the bundle of hollow fiber membranes, but the above-mentioned problems regarding the uneven flow impingement in the areas directly facing the supply conduit persists to some extent here as well.

Moreover, the design described in the above-referenced document causes a markedly increased pressure drop in the gas stream to achieve the described tangential inflow of the gas stream through the openings into the bundle of hollow fiber membranes.

### SUMMARY OF THE INVENTION

The present invention provides a moisture exchange module able to achieve an adequate tangential inflow of a gas stream in an efficient operation that permits an as compact as possible construction of the module.

In an exemplary embodiment of the present invention, a moisture exchange module comprises a moisture-permeable hollow fiber membrane shell space with a bundle of moisture-permeable hollow fiber membranes being arranged in the shell space for receiving a first gas stream. A conduit member is coupled to the shell space for supplying a second gas stream for flow around the hollow fibers. Pursuant to a feature of the exemplary embodiment of the present invention, a mechanism is arranged and configured in the conduit member to produce a swirling motion in the second gas stream.

In accordance with another feature of the present invention, the exemplary embodiment of the moisture exchange module is used in a fuel cell system to provide humidified air to humidify components of the fuel cell system thereby protecting the same from drying out, and thus, from damage and/or premature aging.

### BRIEF DESCRIPTION OF THE DRAWINGS

FIG. 1 is a schematic drawing of a fuel cell system having a moisture exchange module according to an exemplary embodiment of the present invention.

FIG. 2 is a longitudinal section through an exemplary embodiment of a moisture exchange module suitable for use in the fuel system of FIG. 1.

FIG. 3 is a cross sectional view of a first exemplary embodiment of an element arranged and configured for producing a swirling motion in a fluid flow.

FIG. 4 is a cross sectional view of a second exemplary embodiment of an element arranged and configured for producing a swirling motion in a fluid flow.

FIG. 5 is a cross sectional view of a first exemplary design for the moisture exchange module of FIG. 2.

FIG. 6 is a cross sectional view of a second exemplary design for the moisture exchange module of FIG. 2.

FIG. 7 is a longitudinal section of an alternative embodiment of the moisture exchange module of FIG. 2.

FIG. 8 is a longitudinal section of a further alternative embodiment of the moisture exchange module of FIG. 2.

### DETAILED DESCRIPTION OF THE PREFERRED EMBODIMENTS

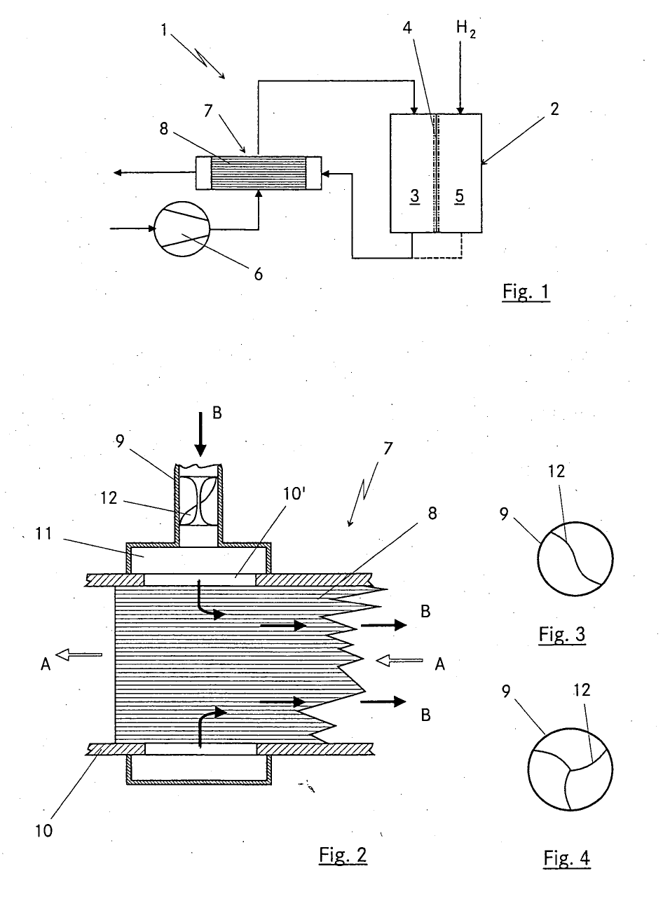

Referring now to the drawings, and initially to FIG. 1, there is shown a schematic drawing of a fuel cell system having a moisture exchange module according to an exemplary embodiment of the present invention. The fuel cell system includes a fuel cell 2, in which a cathode chamber 3 is separated from an anode chamber 5 by a proton-conducting membrane (PEM) 4. The fuel cell 2 is able to generate electric power, in a generally known manner, from hydrogen (H₂) in its anode chamber 5 and air in its cathode chamber 3. The fuel cell 2 may be configured as a single fuel cell, but can also be configured as an arrangement of a plurality of fuel cells in the form of a so-called a fuel cell stack. To protect proton-conducting membrane 4 from drying out, and thus, from damage, the air supplied to cathode chamber 3 via a compressor 6 is humidified in a schematically indicated moisture exchange module 7 by the exhaust gases flowing out of fuel cell 2.

In the exemplary embodiment of the moisture exchange module 7 shown in FIG. 1, the moist exhaust gas of the fuel cell 2 flows through a bundle 8 of hollow fiber membranes, with the air that is to be humidified and intended for use in the fuel cell 2, flowing around the outer surfaces thereof. The moisture present in the exhaust gas is transferred through the water vapor-permeable hollow fiber membranes to the air flowing to the cathode chamber 3, so that this air is humidified and, for its part, humidifies the proton-conducting membrane 4, thereby protecting the same from drying out, and thus, from damage and/or premature aging.

Since there is a higher pressure drop in the actual hollow fiber membranes than in the flow around the same, the arrangement of the compressor 6 shown here is particularly efficient because, in this way, a higher internal pressure can be achieved in the fuel cell 2 with the same compressor capacity. Thus, for a given internal pressure, it is possible to minimize the size and capacity of the compressor 6 as well as its energy consumption on the one hand, and, on the other hand, for a given size and capacity of the compressor 6, the efficiency of the fuel cell 2 can be increased due to the improved thermodynamics at higher internal pressure.

Depending on the fuel cell system 1 used, the anode chamber 5 of the fuel cell 2 is supplied with hydrogen from a hydrogen reservoir or with hydrogen produced by a gas generation system, for example, from a liquid hydrocarbon. In a pure hydrogen system, the anode chamber 5 is operated in a dead-end mode or with an anode loop, whereas when using hydrogen that is produced in the gas generation system, residual gases are discharged from the anode chamber 5 as exhaust gas. Accordingly, the moist exhaust gas used for humidification may come either from the cathode chamber 3 alone or from both the cathode chamber 3 and the anode chamber 5, as is indicated in FIG. 1 by the dashed connection between the anode chamber 5 and the exhaust gas from cathode chamber 3.

If required by the fuel cell system 1 of FIG. 1, the humidified supply air may at least partially be used also for other purposes, for example, to provide at least part of the amount of water required to produce a hydrogen-containing gas from, for example, liquid hydrocarbon, such as is described in DE 103 09 794.

The following explanations refer in each instance to the above-described exemplary embodiment of the moisture exchange module 7 as shown in FIG. 1, in the fuel cell system 1. However, the present invention is not intended to be limited to such uses of the moisture exchange module 7 of the present invention.

FIG. 2 illustrates a longitudinal section through an exemplary embodiment of the moisture exchange module 7. Shown here is a portion of the bundle 8 of hollow fiber membranes through which flows the exhaust gas, designated in FIG. 2 as a first gas stream A (here indicated by the light arrows). At the same time, the air to be humidified, designated in FIG. 2 as a second gas stream B (dark arrows), flows around the hollow fiber membranes. In the above-described example of the fuel cell system 1, this means that moist exhaust gas stream A humidifies supply air B in the process.

Via a conduit member 9, the gas stream B enters the area defined by a shell space surrounding the hollow fiber membranes, which is formed by a housing or shell 10. For the purpose of uniform supply, the shell space 10 is surrounded by an annular space 11 in a preselected area. The gas stream B is supplied to the annular space via the conduit member 9. The gas stream B then passes from the area of the annular space 11 into the area of the bundle 8 via suitable openings 10′ formed in the shell 10 in a manner such that it is distributed over almost the entire circumference of the shell space, so that it can uniformly and efficiently flow around all regions of the bundle 8 of hollow fiber membranes, to the greatest extent possible.

Typically, the bundle 8 of hollow fiber membranes has a circular shape in cross-section, resulting in a rotationally symmetric design for the bundle 8, the shell 10, and the annular space 11, such as is shown in FIG. 2. In principle, however, other types of construction, for example, an angular, oval or other cross-section, are also possible. Accordingly, in such a case, the “annular” space 11 would then not be circular, but angular or oval in shape, and so on.

The discharge of the gas stream B from moisture exchange module 7 is irrelevant to the present invention, and is therefore not shown here. However, the discharge could be, for example, also via a comparable annular space at the other end of moisture exchange module 7 or bundle 8 of hollow fiber membranes.

It is an aim to achieve as uniform a flow as possible across the available cross-section of annular space 11 around the entire circumference of moisture exchange module 7 or shell 10 to be able to ensure flow around all hollow fiber membranes of the bundle 8. This makes it possible to minimize the exchange surface area, and thereby ultimately also the length of the bundle 8, that is, of the entire moisture exchange module 7. Then, a compact and yet very efficient moisture exchange module 7 is achieved.

In order to achieve as uniform a flow as possible across the available cross-section of all hollow fiber membranes of the bundle 8, and thus, to be able to minimize the exchange surface area, and thereby ultimately also the thickness and length of the bundle 8, that is, the size of the overall moisture exchange module, the gas stream B flowing into the annular space 11 and from there into the shell 10, needs to be effectively distributed. In order to achieve a uniform distribution of the gas stream B to the area of the entire bundle of hollow fiber membranes, there is provided, according to an exemplary embodiment of the present invention, a mechanism for producing a swirling motion in the gas stream B. The swirling motion of the gas stream B achieved in this manner allows the gas stream B to be very effectively distributed in the annular space 11, and thus across the entire area or diameter of the bundle 8 of hollow fiber membranes. Thus, the inflowing gas stream B is given a swirling motion sufficient to allow uniform distribution in an annular space of rather small size with an acceptable flow resistance caused by the mechanism for producing the swirling motion. In this manner, the moisture exchange module of the present invention allows very efficient moisture exchange at a high exchange rate per unit volume of the bundle 8 of hollow fiber membranes. Thus, the present invention permits implementation of an exceptionally compact moisture exchange module.

In order to ensure such a uniform distribution for a suitably small unit size and an annular chamber 11 having an outside diameter only moderately exceeding the diameter of the shell 10, according to an exemplary embodiment of the present invention, the mechanism for producing a swirling motion in the gas stream B comprises an element 12 arranged in the conduit member 9. The swirling motion of the gas stream B achieved in this manner results in a very effective distribution of the gas stream B in the entire annular space 11. Thus, the exemplary design illustrated in FIG. 2 permits implementation of an exceptionally compact moisture exchange module 7.

According to the exemplary embodiment of the present invention, the element 12 for producing a swirling motion in the gas stream B, which is illustrated in FIG. 2 only by way of example, may, for example, be made of a twisted strip of a sheet material, resulting in a spirally shaped/helically shaped element. The strip may be made, for example, from a sheet of corrosion-resistant metal or the like. In that case, it is designed to be linear, that is, as a straight or curved line, in cross-section, resulting in a cross-sectional view of the element 12 such as is schematically shown in FIG. 3. Analogously, a twisted element shaped like an at least three-rayed star in cross-section can also be used. Such an element is shown by way of example in the cross-sectional view in FIG. 4. It may be made from either metal strips, which are welded or glued together, or, for example, from an extruded profile. Unlike the examples shown in FIGS. 3 and 4, the line or rays may also be straight in shape. However, curved lines should be preferred here because when making the element in the simplest way, by, for example, merely twisting the element, the lines obtained are more likely to have a curved shape, which, from a fluid mechanics point of view, is beneficial because the gas stream is accelerated to different extent, depending on the distance from the central longitudinal axis of the conduit member 9.

In order to achieve sufficient swirling motion of the gas stream B with an acceptable flow resistance in the same, the element or strip may be twisted by about 70° to 270°, in particular, by a half turn (180°). Thus, the inflowing gas stream B is given a swirling motion sufficient to allow uniform distribution in the annular space 11 with an acceptable effort in terms of the flow resistance caused by element 12.

In the exemplary embodiment of the present invention, the annular space 11 may particularly advantageously be located in the area of the end of bundle 8 of hollow fiber membranes where gas stream A flowing through the hollow fiber membranes exits the same. Thus, it is achieved that the gas stream A flowing in the hollow fiber membranes and the gas stream B flowing around the hollow fiber membranes flow in counter-current relation, at least over a long length of the bundle 8. Such a counter-current flow of gas streams A, B allows the greatest possible difference in moisture concentration to be achieved between gas stream A and B on average in all regions of the bundle 8. Since this difference in moisture concentration is the driving force behind the exchange of moisture through the hollow fiber membranes, the counter-current flow ensures the best possible exchange of moisture between gas streams A, B. This, too, ultimately serves to optimize moisture exchange module 7 in terms of efficiency and size.

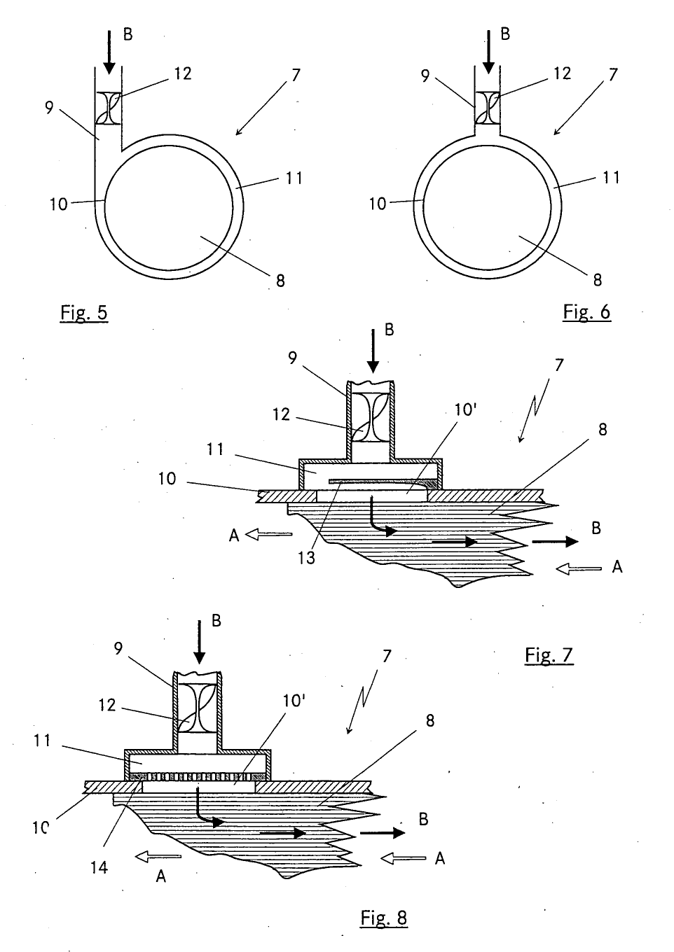

According to a feature of the present invention, the mechanism for producing the swirling motion in gas stream B, the element 12, provides excellent distribution of the gas stream B to the annular space 11. Therefore, the gas stream may be supplied through conduit element 9 optionally either tangentially, as shown in the example in FIG. 5, or centrally, as shown in FIG. 6. In particular, the choice of a tangential or central inlet may be made depending on the space available and on the diameter of the shell space.

Moreover, it is possible to provide a deflector element 13 in the annular space 11, such as are shown in the partial sectional view of moisture exchange module 7 illustrated in FIG. 7. In this instance, the deflector element 13 is formed in the annular space 11 in such a manner that it is arranged between the supply conduit 9 and the entrance to the shell space 10. Thus, deflector element 13 deflects the flow of the gas stream B in such a way that the gas stream B is prevented from flowing directly into the shell space. This further promotes the distribution of the gas stream B to the entire annular space 11 with the advantages mentioned above.

To this end, in a preferred embodiment of the present invention, the deflector element 13 has a rotationally symmetric design. Because of this, the gas stream B is deflected by the deflector in such a way that it flows in a flow direction parallel to the hollow fiber membranes, at least over part of its path. This section of flow, which, according to FIG. 7, runs parallel to and in the direction of the internal flow of the gas stream A in the hollow fiber membranes, allows the gas stream B to flow in very uniformly between the hollow fiber membranes. In this instance, the inflow location is as close as possible to the end of the hollow fiber membranes, allowing use of their entire length that can be flown around by the gas stream B, that is, the entire length except for the end regions of the bundle 8, which are encapsulated to seal the flow inside the hollow fiber membranes from the flow outside the hollow fiber membranes.

Another alternative embodiment of the annular space 11 is shown in FIG. 8. In this exemplary embodiment, the region between the annular space 11 and the shell space is designed in such a manner that the gas stream B flows, from the annular space 11, in between the hollow fiber membranes of the bundle 8, through a plurality of openings which are distributed around the circumference of the shell space and which are implemented here as a perforated plate 14. The perforated plate14 is designed with such that the uniform distribution of the gas stream B flowing in between the hollow fiber membranes can be further improved by the pressure drop created in the region of perforated plate 14.

The perforated plate 14 may be located only in portions of the annular space 1 1. However, a rotationally symmetric design of the perforated plate 14, which allows them to be simply slipped onto the shell 10 in the area of annular space 11, is particularly convenient and easy to manufacture.

Regarding the materials that can be used for deflector element 13 and the perforated plate 14, reference is made to the above description of the element 12.

All of the various alternative designs for the moisture exchange module 7 and/or the annular space 11 described herein may be combined with each other in any desired way.

According to a feature of the present invention, the moisture exchange module 7 may be advantageously used, in particular, for drying and humidifying process gas streams, for example, to humidify the supply air to the fuel cell system using the exhaust gas from the fuel cell. Depending on the design and use of such a fuel cell system, for example as a propulsion system in vehicles, the compact and lightweight construction combined with a still very high moisture exchange rate is of decisive importance. The moisture exchange module 7 of the present invention meets these requirements, thus providing an excellent moisture exchange module for the use mentioned above.

In the preceding specification, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

1. A moisture exchange module, which comprises:
a. a moisture-permeable hollow fiber membrane shell space;
b. a bundle of moisture-permeable hollow fiber membranes arranged in the shell space for receiving a first gas stream;
c. a conduit member coupled to the shell space for supplying a second gas stream for flow around the hollow fibers; and
d. a mechanism arranged and configured in the conduit member to produce a swirling motion in the second gas stream.

2. The moisture exchange module of claim 1 wherein the mechanism comprises an element shaped in a spiral along a flow direction of the second gas stream.

3. The moisture exchange module of claim 1 wherein the mechanism comprises an element helically shaped along a flow direction of the second gas stream.

4. The moisture exchange module of claim 1 wherein the mechanism comprises an element that has an end onto which a flow of the second gas stream impinges first, the end is twisted by 70° to 270°, with respect to an other end of the element.

5. The moisture exchange module of claim 1 wherein an annular space surrounds the shell space in an area of one end of the bundle of hollow fiber membranes.

6. The moisture exchange module of claim 5 wherein the annular space is arranged in an area of an end of the bundle of hollow fiber membranes where the first gas stream flowing through the hollow fiber membranes exits the bundle.

7. The moisture exchange module of claim 5 wherein the conduit member communicates with the annular space centrally with respect to a cross-section of the bundle of hollow fiber membranes.

8. The moisture exchange module of claim 5 wherein the conduit member communicates with the annular space tangentially with respect to a cross-section of the bundle of hollow fiber membranes.

9. The moisture exchange module of claim 5 wherein a deflector element is arranged in the annular space between the conduit member and the shell space, the deflector element being arranged for deflecting the flow of the second gas stream so as to prevent the gas stream from flowing directly into the shell space.

10. The moisture exchange module of claim 9 wherein the deflector element is arranged and configured such that the second gas stream is deflected by the deflector element such that the second gas stream flows in a flow direction parallel to the hollow fiber membranes of the bundle, at least over part of its path.

11. The moisture exchange module of claim wherein a perforated plate is arranged in the annular space between the conduit member and the shell space, such that the second gas stream flows from the annular space into the shell space through a plurality of openings formed on the perforated plate.

12. A fuel cell system comprising:
a. at least one fuel cell;
b. a moisture exchange module coupled to the at least one fuel cell;
c. the moisture exchange module including:
i. a moisture-permeable hollow fiber membrane shell space;
ii. a bundle of moisture-permeable hollow fiber membranes arranged in the shell space for receiving a first gas stream;
iii. a conduit member coupled to the shell space for supplying a second gas stream for flow around the hollow fibers; and
iv. a mechanism arranged and configured in the conduit member to produce a swirling motion in the second gas stream.

13. The fuel cell system of claim 12 wherein the moisture exchange module is arranged to humidify supply air to the fuel cell system using a moist exhaust gas from at least one fuel cell of the fuel cell system.

14. The fuel cell system of claim 13 further comprising a compression device arranged to deliver the supply gas along an outer surface of the hollow fiber membranes to the fuel cell system, the moist exhaust gas being arranged to flow through the hollow fiber membranes.
